(19) United States
(12) Patent Application Publication
(10) Pub. No.: US 2004/0056477 A1
(43) Pub. Date: Mar. 25, 2004

(54) Safe surgery

(76) Inventor: Carol Jean Emery Bruce, San Anselmo, CA (US)

Correspondence Address: Thomas W. Cook, Thomas Cook Intellectual Property Attorneys, P.O. Box 1989, 3030 Bridgeway, Suite 425-430, Sausalito, CA, 94965, US

(21) Appl. No.: 10/252,165

(22) Filed: Sep. 23, 2002

(51) Int. Cl. B42D 15/00

(52) U.S. Cl. 283/81

(57) ABSTRACT

An adhesive label with bold words, logo and/or universally accepted colors and symbols to indicate which body site the patient undergoing surgery wants and particularly does not want to be operated on. The patient will peel off and place a bright colored temporary label or sticker (FIG. 1) and place it just above the operative site for the sole purpose of encouraging patient involvement in the correct site identification. The nurse will then confirm the site against the signed surgical consent, and apply a red label or decal (FIG. 2) to the opposite or wrong side (red for stop) which can not be removed until after the surgery. A soft self-adhering band can be used as an alternative for sensitive skin with the green and red labels attached.

### CROSS REFERENCE TO RELATED APPLICATIONS

Identification Tag; U.S. Pat. No. 6,092,321; Cheng; Jul. 25, 2000 and Surgical Clothing and labeling means therefore; U.S. Pat. No. 4,947,867; Keeton; Aug. 14, 1990

### COPYRIGHT STATEMENT

Record of Invention filed May 20, 2002; Copyright filed Jun. 19, 2002; Trademark filed Jun. 25, 2002 S#76/425144

### BACKGROUND OF INVENTION

This invention is a labeling process and/or system utilizing bold words, logos, or symbols and several methods to help keep the label visible before and during surgery. There is a printed ogo on surgical tape, a decal format, or a printed sign on a soft adjustable strap (for sensitive or allergic patients). This labeling process is intended to mark the patient's non-operative site so as not to interfere with the surgeons scope of practice. The “Safe Surgery” system has been designed for the sole purpose of alerting the surgeon that they are on the “wrong side” of the body so they can quickly move to the correct side, preventing a terrible error, (and error that is somewhat underestimated by the general public).

### SUMMARY OF INVENTION

Currently (and surprisingly!) There is no process to avoid operating on the wrong side of the human body. This is particularly problematic because the patient is typically sedated and is thus not in the position to stop the error from occurring. Despite any existing precautions and procedures, mistakes in surgery continue to occur, the most egregious of which is “wrong side surgery.” In most cases, this could have been prevented if there was a visible mark indicating where to, and most importantly where NOT to operate, (A mistake only occurs by going to the wrong body part to begin with). This reoccurring problem has not been eliminated even with the use of consent forms, health histories and physicals, modern scheduling procedures and repeated questioning up to just moments before the patient is put to sleep. It s an awareness of this “flaw” in our current system that fuels this patent, without which, these serious injuries will undoubtedly continue to occur.

### BRIEF DESCRIPTION OF DRAWINGS

FIG. 1 is a hospital grade, adhesive backed plastic tape, similar to a TEGADERM with bold words, logo and/or symbol. This printed tape is approximately 2″×2″ but will vary slightly in size, shapes, logo designs and words, in order to accommodate different body areas (parts), and body sizes.

FIG. 2 is an FDA approved decal made, according to this invention. It is a printed design with bold words, logo and/or symbol. A prototype has been made and produced with the same clarity as any paper or printed adhesive label. It is easily applied, appears and acts just like the adhesive label but is deal for those with tape allergies.

FIG. 3 is a soft, adjustable band with either VELCRO ro self adhering qualities like COBAN, that can be easily applied and removed without pulling the skin (as tape does(, oor obscuring the logo (as really wrinkly skin would do). This band would hold the printed logo (on durably thick paper) with the same bold words, logo and/or symbol needed to catch the attention of the surgeon. It should also be used to indicate the correct site without obscuring the surgical site while continuing to use the “wrong side Doc” and protecting the “opposite” side at the same time.

### DETAILED DESCRIPTION

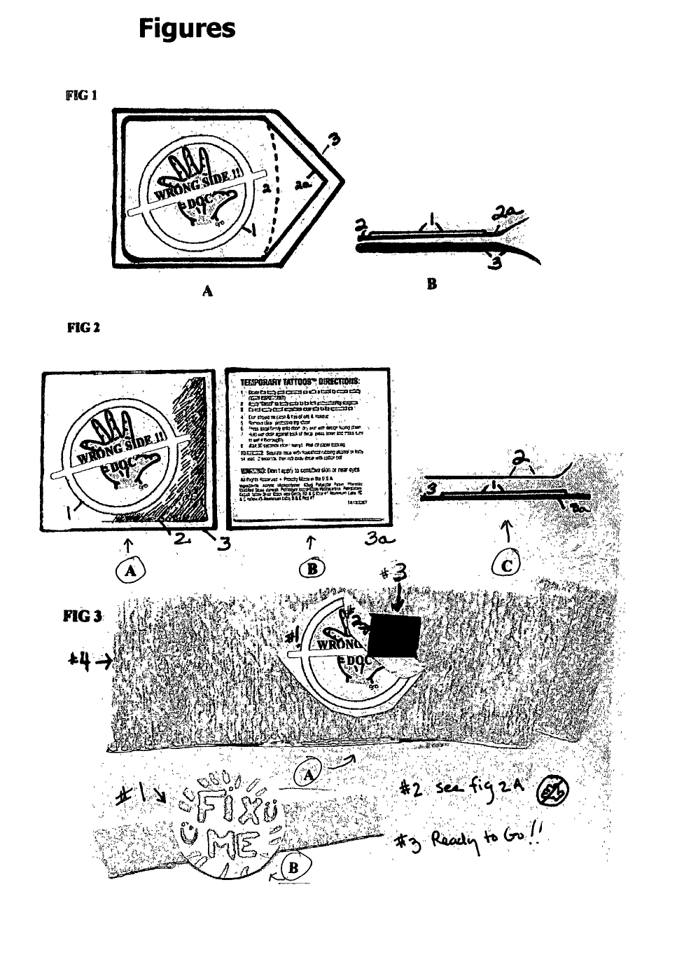

FIG. 1

A). Illustrates a front view of the ‘safe Surgery’ system.

(1) A logo with bold words and/or bright symbol printed on an adhesive label.

(2) An adhesive label made of hypo-allergenic, pliable plastic material with an adhesive underside and a small pull-tab to support the label for easy application. Ideally a thicker material can be used and printed on like regular bandage tape, in which case the support would then, not be necessary. A small pull tab would still be helpful as is utilized with most BANDAIDS®.

(2a) A small pull tab made of paper discarded after use.

(3) The protective backing for adhesive.

B). Illustrates side view of the ‘safe Surgery’ system.

(1) The printed logo with bold words, and/or symbol.

(2) The adhesive backed, pliable, plastic label material. (2a) A small pull-tab separating label from backing.

(3) The protective paper backing for adhesive.

FIG. 2

A) Illustrates a front view of a decal version of the ‘safe Surgery’ system.

(1) A logo with bold words and/or bright symbol printed as a decal.

(2) A thin film of plastic, protecting the decal until use.

(3) The absorbent paper backing that decal adheres to until placed on skin.

B) Illustrates backside of absorbent paper with detailed instructions (3a)

C) Illustrates side view of decal version of ‘safe Surgery’ system.

(1) The logo with bold words and/or bright symbol.

(2) A thin film of protective plastic covering decal until use.

(3) The absorbent paper backing holding decal until use and (3a) printed on back with instructions for use.

FIG. 3

A) Illustrates front view of a ‘strap-on’ version of ‘safe Surgery’ system.

(1) A logo with bold words and/or bright symbols printed on supportive paper (sign).

(2) VELCRO™ holds sign on strap may be used to secure strap if self adhering tape isn't used (like COBAN™)

B) Illustrates a child's version of the strap intended for the correct hand while the nurse puts the ‘Wrong side’ decal, securely on the opposite hand.

(1) Shows a positive command logo indicating the correct hand and what to do with it in terms even a child would understand.

(2) refers to the identical logo in FIG. 2)A to be placed on the opposite (wrong side) hand to ultimately protect it!.

1. An apparatus for marking a patient before surgery, comprising:
a positive marker having positive indicia;
means for affixing the positive marker to a patient;
a negative marker having negative indicia; and
means for affixing the negative marker to the patient.

2. The apparatus for marking a patient before surgery of claim 1, in which the positive marker and the negative marker are each stickers.

3. The apparatus for marking a patient before surgery of claim 1, in which the positive marker and the negative marker are each decals.

4. The apparatus for marking a patient before surgery of claim 1, in which the positive marker and the negative marker are each bands.

5. An apparatus for marking a patient before surgery, comprising:
a negative marker having unambiguous negative indicia; and
means for affixing the negative marker to the patient.

6. The apparatus for marking a patient before surgery of claim 5, in which the negative marker is a sticker.

7. The apparatus for marking a patient before surgery of claim 5, in which the negative marker is a decal.

8. The apparatus for marking a patient before surgery of claim 5, in which the negative marker is a band.

9. A method for marking a patient before surgery, comprising the steps of:
selecting a positive marker and a negative marker for affixation to a patient;
handing the positive marker to the patient, with instructions to the patient to affix the positive marker to the patient near the intended surgical site;
confirming the site selected by the patient for affixation of the positive marker is the correct surgical site; and
placing a negative marker on the corresponding wrong side site of the patient on the other side of the patient's body.

10. The method for marking a patient before surgery of claim 9, further comprising the step of checking both sides of the patient for the presence of both a positive marker and a negative marker.

11. The method for marking a patient before surgery of claim 9, further comprising the step of checking the site intended for surgery in an operating room for the presence of either a positive marker or a negative marker.
